(19) United States
(12) Patent Application Publication
(10) Pub. No.: US 2016/0186061 A1
(43) Pub. Date: Jun. 30, 2016

(54) FLAME RETARDANT COMPRISING GRAPHENE OXIDE DOPED PHOSPHORUS ON THE SURFACE

(71) Applicant: INDUSTRY-ACADEMIC COOPERATION FOUNDATION YONSEI UNIVERSITY, Seoul (KR)

(72) Inventors: Seong Chan JUN, Seoul (KR); surajit Some, Seoul (KR); Min Sik NAM, Seongnam-si (KR)

(21) Appl. No.: 14/979,413

(22) Filed: Dec. 27, 2015

(30) Foreign Application Priority Data
Dec. 26, 2014 (KR) 10-2014-0191023

(51) Int. Cl. C09K 21/04; D06M 11/70; D06M 11/72; D06M 11/74

(52) U.S. Cl. CPC C09K 21/04; D06M 11/74; D06M 11/70; D06M 11/72; D06M 2200/30

(57) ABSTRACT

The present invention relates to a flame retardant comprising graphene oxide wherein phosphorus is doped on the surface and a preparation method thereof, and more specifically relates to a technique relating to a flame retardant, which dopes phosphorus component having flame retardance in a very high rate through a simple method, based on the graphene oxide, a form wherein graphene which is difficult to be synthesized chemically is oxidized. When coating the flame retardant on a subject such as fabric, since it forms a layer preventing the transfer of heat in combustion, there are advantages that it can effectively prevent fire without a change of the surface, except for a little shrinkage, has the remarkable durability without forming any toxic material which can be harmful to a human and environment, and it can be mass-produced with low price, and it can be applied to the various industrial fields.

### CROSS-REFERENCE TO RELATED APPLICATIONS

This application claims priority to Korean Patent Application No 10-2014-0191023, filed on Dec. 26, 2014, which is hereby incorporated by reference in its entirety into this application.

### BACKGROUND OF THE INVENTION

1. Field of the Invention

The present invention relates to a flame retardant comprising graphene oxide wherein phosphorus is doped on the surface and a preparation method thereof, and more specifically relates to a technique relating to a flame retardant, which dopes phosphorus component having flame retardance in a very high rate through a simple method based on graphene oxide, a form wherein graphene which is difficult to be chemically synthesized is oxidized.

2. Description of Related Art

Most of high-molecular materials having a property which is easy to burn are made to become non-combustible by adding a flame retardant or chemically reacting them to introduce flame retardant elements into a molecule. There are increased needs for flame-retardance by considering safety in the case of fire due to that the high-molecular materials have been used in almost all of the fields such as a computer, TV, parts of an electronic equipment, as well as an automobile, building materials, vehicles, flame-retardant finish of a general fiber, and the like.

Accordingly, inflammability regulation for various plastic, rubber, fiber, paper and the like has recently been tightened. The regulation for the flame retardance is mostly ruled within a criterion set forth in each nation, such as Underwriters laboratories Inc. (UL), Canadian Standards Association (CSA), Japanese Industrial Standards (JIS), American Society for Testing Materials (ASTM), Deutsches Institut fur Normung (German Institute for Standardization; DIN), etc. and there are many cases that they can be used only the case of being satisfied by the proper regulation according to the requirement.

A performance required in the flame retardant generally includes i) a little occurance of fuming and toxic gas in combustion, ii) a good dispersibility due to an excellent compatibility for raw materials and additives, iii) no occurance of a decomposition in a molding process due to a securance of the sufficient thermostability at the temperature of the molding process for a product and no movement of the flame retardant from a final product, iv) no bad influence on a material property of the product, such as mechanical, electrical, plastic fprocessibility and the like.

The flame retardants are classified into an additive type and reactive type, or halogen-based and non-halogen-based one. Halogen-based flame retardant is prepared by using halogen (Cl, Br) compounds, and non-halogen-based flame retardant includes phosphorous compound, nitrogen-containing compound, inorganic compound, and the like. Since the phosphrous-based compound among them has non-toxic, eco-friendly property, it is paid much attention together with the inorganic compound, instead of halogen-based flame retardant which is gradually subjected to regulations. The representative examples for phosporous-based compound can be phosphoric acid ester, red phosphorous, polyphosphoric acid ammonium and the like.

As a general flame retardant, the halogen-based flame retardant in which a brome-based one is mainly included has been used, but its use is limited due to the environmental problems and various regulations, and since antimony trioxide flame retardant is also limited by regulations and therefore, necessity needs for replacing new flame retardant have been increased. Many flame retardants have been developed due to such needs, but there is a problem that their effects are unsatisfactory than the halogen-based flame retardant or antimony trioxide.

Meanwhile, the phosphrous-based compound has the flame retardant effect increasing in propotional to phosphorous content and an additive-type flame retardant having relatively high phosphorus contents among products emerging on the market includes ANTI blaze 1045 (Albright & Wilson Americas). However, since most of phosphorus-based flame retardants has a small molecular weight and has a phenomenon lowering durability, hygroscopic property, transivity, adhesion power, water-proofing property, and the like when using it, there is a disadvantage that the flame retardant effect is also lowered.

Therefore, there is an urgent need for developing a new flame retardant which does not lower the original mechanical performance of the subject, such as a durability and does not form toxic materials which are harmful to a human or environment when it is burned to generate the toxic gas or is washed out, and has the improved quality and the high durability, while being able to maximize the flame retardant property of the flame retardant itself, which can reduce a risk of fire.

### SUMMARY OF THE INVENTION

The present invention has been made in view of the above-mentioned problems, and an object of the present invention is to provide a flame retardant which is harmless on the environment and has the enhanced quality and high durability, by doping phosphorus component having the flame retardance at the high rate through a simple method, based on graphene oxide, the form wherein graphene which is difficult to chemically synthesize is oxidized.

To accomplish the above-mentioned object, according to one embodiment of the present invention, the present invention provides a flame retardant including graphene oxide wherein phosphorus component is doped on the surface.

In this case, the above phosphorus component can be at least one of phosphoric acid and polyphosphoric acid, and preferably the phosphorus component is doped on the surface of the graphene oxide in the content of the range of 24˜35 wt %, and more preferably it is doped in the content of about 29 wt %.

The present invention also provides fire retardant fabrics on which the above-mentioned flame retardant is coated.

Meanwhile, in order to achieve the above-mentioned object, according to other embodiment of the present invention, the present invention provides a method for preparing a flame retardant, which comprises a step for preparing graphene oxide in a chamber; and a step for adding at least one of phosphorus component of phosphoric acid and polyphosphoric acid to the chamber to dope the phosphorus component on the surface of the graphene oxide.

At this time, in the step for doping the phosphorus component, it is preferable that pH range is controlled by adding a basic material to the chamber, or by adding the basic material after doping step of the phosphorus component.

As the basic material at this time, sodium hydroxide, potassium hydroxide or ammonium hydroxide can be used, and it is more preferable to control from the strong acid condition of pH 3˜4 to pH 5 by using such basic material.

In addition, the step for doping phosphorus component can be performed at the temperature of the range of 80˜100° C. for 10˜15 hours, and in the step for doping phosphorus component, it is preferable to dope the phosphorus component in the content of the range of 24˜35 wt % on the surface of graphene oxide, and is more preferable to dope the phosphorus component in the content of 29 wt %.

Meanwhile, in order to achieve the above mentioned object, the present invention provides a method for coating the flame retardant according to another example of the present invention, which comprises a step for preparing graphene oxide in the chamber; step for adding at least one of phosphorus component of phosphoric acid and polyphosphoric acid and the basic material to the chamber to dope the phosphorus component in the content of the range of 24˜35 wt % on the surface of the graphene oxide, while controlling the strong acid condition of pH 3˜4 to the range of about pH 5; and step for coating the graphene oxide wherein the phosphorus component is doped on the surface of the subject.

Selectively, the present invention provides a method for coating the flame retardant, which comprises step for preparing graphene oxide in the chamber; step for adding at least one of phosphorus component of phosphoric acid and polyphosphoric acid to the chamber to dope the Phosphorus component in the content of the range of 24˜35 wt % on the surface of the graphene oxide; step for controlling the graphene oxide wherein phosphorus component is doped to about pH 5 by using the basic material; and step for coating the graphene oxide wherein the phosphorus component is doped on the surface of the subject.

At this time, the subject can be an interior or exterior material, furniture or fabrics, and it is preferable to dope the phosphorus component in the content of 29 wt % on the surface of graphene oxide in the step for doping phosphorus component.

### BRIEF DESCRIPTION OF DRAWINGS

FIG. 1 is a total schematic diagram for the flame retardant comprising graphene oxide wherein phosphorus is doped on the surface according to the present invention and the method for preparing it.

FIG. 2 is a flow chart for the method for preparing the flame retardant according to the present invention.

FIG. 3 represents (a) XPS spectra for graphene oxide wherein phosphorus is doped (PGO) and the general graphene oxide (GO), (b) C₁ₛ spectra of PGO, (c) Op₁ₛ spectra of PGO, and (d, e) P₂ₚ, P₂ₛ spectra of PGO, as for graphene oxide wherein phosphorus is doped on the surface, as prepared according to a preferable example.

FIG. 4 represents (a) TGA thermograms under the heating condition of 20° C. per minute in the air, and (b) Raman spectra of PGO and GO, as for graphene oxide wherein phosphorus is doped on the surface, as prepared according to a preferable example.

FIG. 5 is a photograph for a burning test by using clothes wherein PGO and GO according to one preferable example of the present invention are coated thereon, respectively.

FIG. 6 represents SEM image (a) before combustion and (b) after burning for the cloth surface on which graphene oxide wherein phosphorus is doped is coated, as prepared according to one preferable example.

### DETAILED DESCRIPTION OF THE INVENTION

Hereinafter, an explanation on preferable examples of the present invention will be given in detail with reference to the attached drawings. Prior to this, terms or words used in the specification and claims are not to be construed to limit to the common or dictionary meanings, and they should be construed as the meanings and concept complying with the technical ideas.

Throughout the specification, when it is stated that any member is placed “on” the other member, it includes the case that any member is faced with another member, as well as the case that another member is present between two members.

Throughout the specification, when it is stated that any part “includes” any constitutive element, it means that it does not exclude another constitutive element, but additionally includes another constitutive element, unless there is any specific statement to the contrary.

Term, such as “the first,” “the second,” etc. is for distinguish one constitutive element from other constitutive elements, and the scope of right is not to be limited to such terms. For example, the first constitutive element can be named as the second constitutive element, and similarly, the second element can also be named as the first constitutive element.

An identification code in each step is used for the convenience of explanation and do not explain the order of each step, each step can be performed differently from the stated order unless it obviously state the specific order from the context. That is, each step can also be performed equally to the stated order and can also be performed substantially simultaneously and can also be performed according the reversed order.

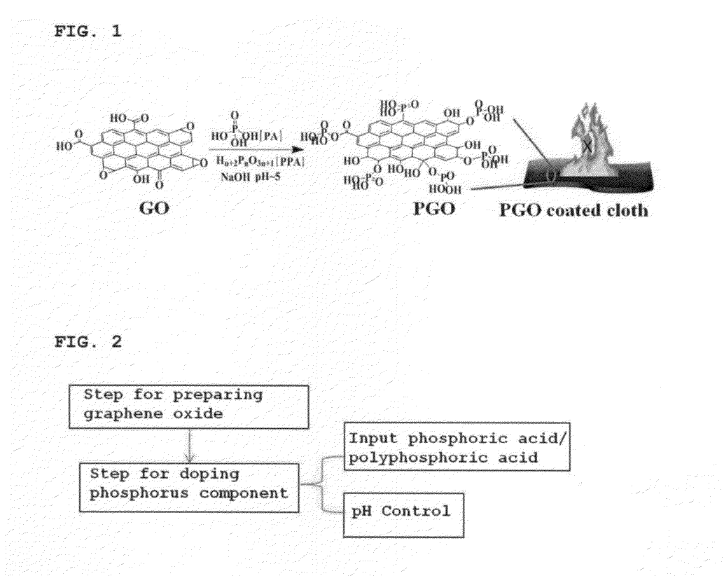

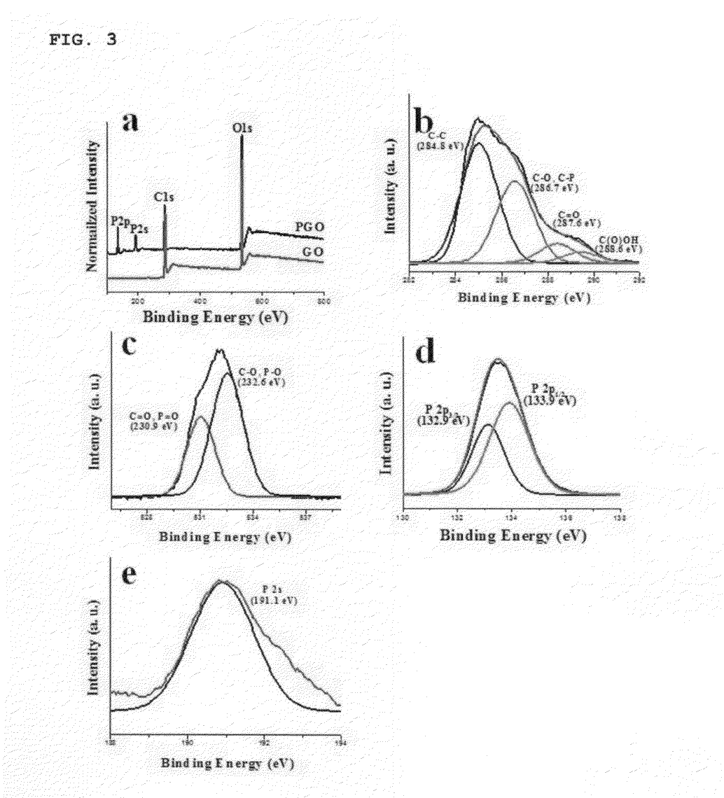

The present invention, at first, provides the flame retardant comprising graphene oxide wherein phosphorus component is doped on the surface according to one preferable example. A schematic total mimetic diagram for the flame retardant according to the Example and its preparation method is depicted in FIG. 1.

Graphene is two-dimensional plane structure made of carbon atoms, and has various properties such as electrical conductivity, etc. and thus, is spotlighting as new materials of the next generation. In addition, in the case of graphene oxide, it is the one wherein the functional group such as carboxyl group is formed, and has an advantage having various reactivity that the pure graphene does not have, and has an excellent productivity and thus, is easy to use industrially.

Graphene is the safest type of material thermodynamically of all carbon allotropes, but since it has a very low chemical reactivity, it has a shortcoming that a synthesis into a new compound, i.e., application is not easy and thus, the oxidized form of graphene oxide, or double-GO wherein the oxidized level is intensified is spotlighted in various technical fields.

Meanwhile, methods for preparing the flaming retardant of the prior art are very various. For example, there is a technique for treating the material having the flame retardance on its surface, technique using nano-synthesized fiber or technique utilizing fabrics having the flame retardance naturally, and the like. Among these, there is a technique utilizing the material which generates nonflammable gas, and this technique is the method allowing the nonflammable gas to form a coating on the surface of the subject when applying the heat to prevent oxygen. Such many methods are limited in their uses due to the generation of toxic material, lack of durability and the like, despite their effectiveness.

Graphene oxide wherein phosphorus is doped according to the present invention does not use the manner that toxic gas is generated when applying the heat, but cools the surface by endothermic reaction and vaporization via the manner that water molecular is hydrated from phosphoester, phosphodiester or phosphoanhydride, etc. to form a layer physically preventing the heat transfer, and thus, exert the flame performance effectively, and in particular, when applying by coating it on fabrics, the phenomenon condensing the heat while blackening the surface of fabrics as black is occurred to additionally make it have the chemical flame retardance.

Phosphorus component is doped as a form of a hetero atom such as phosphoric acid represented in a chemical formula 1:

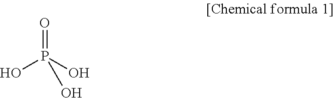

or polyphosphoric acid represented in a chemical formula 2P:

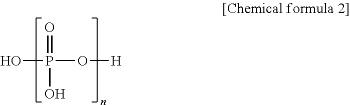

The extent that phosphorus content is doped on the surface of graphene oxide is preferable in a level of the range of 25˜35 wt %, based on the content of weight ratio (wt %). When the content of doping of phosphorus component is less than 25 wt %, since it stays the level of the flame retardance of the prior art phosphorus-based flame retardant (the level of the largest about 23 wt % of the phosphorus component doping content), the enhancement extent of the flame retardant performance is insufficient, and when it exceeds 35 wt %, since the doping level of phosphorus component is excessively increased, and thus it has a bad influence on the material performance of graphene oxide itself, and there is a problem that it is non-economic and non-efficient due to the putting of the unnecessary phosphorus component into the flame retardant mechanism.

As mentioned above, since graphene oxide has the property that is easy to synthesize the hetero atom unlike the pure graphene, while not being harmful to the human and environment, it does not cause any problem for forming the harmful materials to the human or for lowering the durability and is able to dope phosphorus component at the high level than the prior phosphorus-based flame retardant, and thus, can maximize the flame retardant performance.

In addition, it has a low reactivity to the environment in the light of the environment, can be kept for a long time, does not have any toxic material harmful to the human, can be prepared by a simple process and is possible to mass-produce by a low price, and thus, the applicability to the field of whole industry is very high.

Hereinafter, Examples for the flame retardant comprising graphene oxide wherein phosphorus is doped on the surface according to the present invention and its preparation method are explained. However, since they are merely the most preferable one example and do not represent all technical features, it should be understood that there are various equivalents and modification examples replacing them.

### EXAMPLE 1

<Preparation of Graphene Oxide Flame Retardant Wherein Phosphorus Component is Doped>

In order to prepare graphene oxide wherein phosphorus component is doped according to the preferable example of the present invention, at first, graphene oxide (hereinafter, referred to as ‘GO’) is prepared in a reaction chamber. The flow chart for the preparation method of flame retardant of the present invention is depicted in FIG. 2.

Phosphoric acid, polyphosphoric acid or a mixture of phosphoric acid and polyphosphoric acid as a precursor material for doping phosphorus component is added to the reaction chamber wherein graphene oxide is prepared. At this time, it is preferable that the basic material is additionally added so that pH titration is made to progress phosphorus doping smoothly. Specifically, the pH condition in the whole chamber was controlled to keep from the strong acid of 3˜4 to weak acid of pH 5 by adding the basic material such as sodium hydroxide. After completing the preparation as above, the reaction is performed under the temperature condition of 80˜100° C. for 10˜15 hours, preferably under the temperature condition of 90° C. for 12 hours.

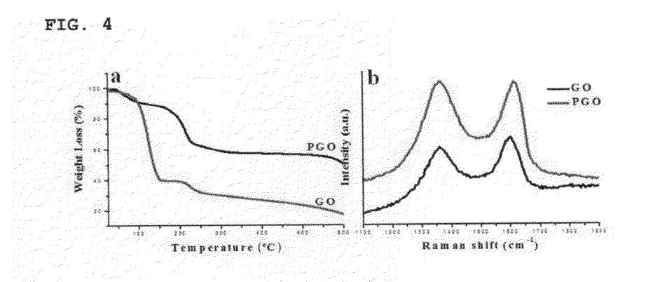

Through the synthesis procedure as above, graphene oxide wherein 29 wt % phosphorus component was doped on the surface was prepared, and it could be identified that PGO wherein phosphorus component was doped on the surface was prepared when referring to PGA thermogram and Raman spectra of FIG. 4.

### EXAMPLE 2

<Combustion Burning Test>

Combustion test for the clothes (fabrics) wherein the flame retardant comprising PGO prepared by the method of the above Example 1 was coated was performed. A general cloth as control 1 and a general cloth wherein the general graphene oxide (GO) wherein phosphorus was not doped was coated as a control 2 were prepared.

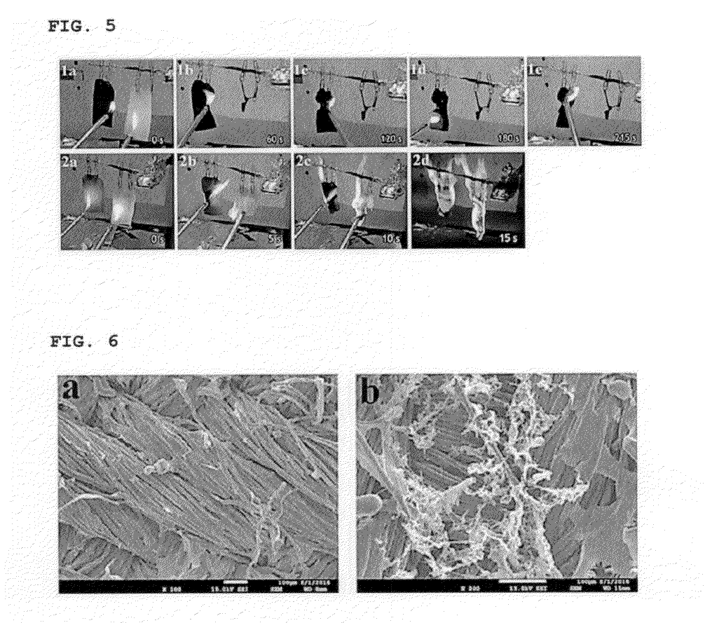

1(a) to 1(e) of FIG. 5 depict photographs of combustion test comparing the cloth wherein PGO is coated with the general cloth (control 1) over time, and 2(a) to 2(d) of FIG. 5 depict photographs of combustion test comparing the cloth wherein GO is coated (control 2) with the general cloth (control 1) over time.

When referring to test photographs, it could be seen that a fire was begun within about 6 seconds for the general cloth (control 1), and within about 10 seconds for the cloth wherein GO is coated (control 2), but there was no fire after 3 minutes for the cloth wherein PGO of the present invention is coated, except for the occurrence of only a little shrinkage.

In addition, when referring to FIG. 6 depicting SEM photographs for the surface of the cloth wherein PGO of the present invention is coated (a) before the fire or (b) after the fire, it could be identified that there was little change in the subject of the coating, the cloth itself, except for the occurrence of a little shrinkage or deformation only in some PGO components coated on the surface after a series of combustion test mentioned above.

It is also possible that the basic material is added to graphene oxide wherein phosphorus component is doped to control the range of pH after the graphene oxide is doped with phosphorus component. Said basic material might be sodium hydroxide, potassium hydroxide or ammonium hydroxide. And the control of pH range by using the basic material is controlled in the range of the strong acid of PH 3˜4 to the weak acid of pH 5.

According to the present invention, since phosphorus having the flame retardance can be doped at the very high rate through an easy and simple process by replacing graphene which is difficult to be synthesized chemically and by utilizing graphene oxide which is relatively easy to be synthesized relatively chemically, a workability of the preparation, ease of the process and convenience of mass production can be provided.

In addition, when the flame retardant is coated on the subject, there are effects that a fire can be prevented, with minimizing a deformation of the subject, the toxic materials which can be harmful to the human or environment are not formed at all, and the remarkable durability can be possessed.

The present invention is not restricted by the specific example and explanation as mentioned above, and any person having ordinary knowledge in the art to which the present invention belongs can practice various modification, without departing from the gist of the present invention and such modification is within the protection scope of the present invention.

What is claimed is:

1. A flame retardant comprising graphene oxide wherein phosphorus component is doped on the surface

2. The flame retardant according to claim 1, wherein the phosphorus Component is phosphoric acid, polyphosphoric acid or a mixture thereof.

3. The flame retardant according to claim 1, wherein the phosphorus component is doped in the content of the range of 24˜35 wt % on the surface of the graphene oxide.

4. The flame retardant according to claim 13, wherein the phosphorus component is doped in the content of about 29 wt % on the surface of the graphene oxide.

5. A fire retardant fabric wherein the flame retardant of claim 1 is coated on the surface.

6. A method for preparing a flame retardant, which comprises:
step for preparing graphene oxide in the chamber; and
step for adding phosphoric acid, polyphosphoric acid or a mixture thereof to the chamber to dope the phosphorus component on the surface of the graphene oxide.

7. The method for preparing the flame retardant according to claim 6, wherein in the step for doping the phosphorus component, the basic material is added to the chamber to control the range of pH.

8. The method for preparing the flame retardant according to claim 7, wherein the basic material is sodium hydroxide, potassium hydroxide or ammonium hydroxide.

9. The method for preparing the flame retardant according to claim 7, wherein the control of pH range by using the basic material is controlled in the range of the strong acid of pH 3˜4 to the weak acid of pH 5.

10. The method for preparing the flame retardant according to claim 6, wherein the step for doping phosphorus component is performed under the temperature condition of the range of 80˜100° C. for 10˜15 hours.

11. The method for preparing the flame retardant according to claim 6, wherein in the step for doping the phosphorus component, the phosphorus component is doped in the content of the range of 24˜35 wt % on the surface of the graphene oxide.

12. The method for preparing the flame retardant according to claim 11, wherein the phosphorus component is doped in the content of about 29 wt % on the surface of the graphene oxide.

13. The method for preparing the flame retardant according to claim 6, wherein after the step for doping the phosphorus component, the basic material is added to graphene oxide wherein phosphorus component is doped to control the range of pH.

14. The method for preparing the flame retardant according to claim 13, wherein the basic material is sodium hydroxide, potassium hydroxide or ammonium hydroxide.

15. The method for preparing the flame retardant according to claim 13, wherein the control of pH range by using the basic material is controlled in the range of the strong acid of pH 3˜4 to the weak acid of pH 5.

16. A method for coating a flame retardant, which comprises:
step for preparing graphene oxide in a chamber,
step for adding at least one of phosphorus component of phosphoric acid and polyphosphoric acid, and the basic material to the chamber to dope the phosphorus component in the content of the range of 24˜35 wt % on the surface of the graphene oxide under a condition of pH 1˜5, and
step for coating graphene oxide wherein the phosphorus component is doped on the surface of a subject.

17. The method for coating the flame retardant according to claim 16, wherein the subject is an interior or exterior material, furniture or fabrics.

18. The method for coating flame retardant according to claim 16, wherein the phosphorus component is doped in the content of 29 wt % on the surface of the graphene oxide in the step for doping the phosphorus component.

19. The method for preparing flame retardant according to claim 16 wherein the basic material is sodium hydroxide, potassium hydroxide or ammonium hydroxide.
